(19) United States
(12) Patent Application Publication
(10) Pub. No.: US 2004/0197019 A1
(43) Pub. Date: Oct. 7, 2004

(54) Apparatus and method for visually inspecting soldered joints

(75) Inventors: Johannes Coleta Maria Van Den Broek, Waalwijk (NL); Lambertus Petrus Christinus Willemen, Dorst (NL); Gerardus Johannes Adrianus Maria Diepstraten, Dongen (NL)

Correspondence Address: BANNER & WITCOFF, 1001 G STREET N W, SUITE 1100, WASHINGTON, DC, 20001, US

(73) Assignee: Vitronics Soltec B.V., Oosterhout (NL)

(21) Appl. No.: 10/763,384

(22) Filed: Jan. 26, 2004

(30) Foreign Application Priority Data
Jan. 29, 2003 (NL) NL 1022517

(51) Int. Cl. G06K 9/00

(52) U.S. Cl. 382/150

(57) ABSTRACT

The invention relates to an apparatus for visually inspecting soldered joints made on a soldered object, comprising: A camera for recording at least one image of the soldered object on which the soldered joints to be soldered are present, a computing device connected to the camera for receiving the signals from the camera that represent the images recorded by the camera, the computing device being arranged for comparing the signals with signals which are representative of correct soldered joints, and a handling device for moving the soldered objects on which the soldered joints to be inspected have been made to a position within the viewing range of the camera.

The invention also relates to a method which is carried out by using the above apparatus.

The present invention relates to an apparatus for visually inspecting soldered joints made on a soldered object.

In the present mass production of electronics, various types of soldering machines are used for making soldered joints. Use is made of wave soldering machines, “reflow” soldering machines or soldering machines for making separate soldered joints, which machines are generally used in combination with each other.

As a result of the increasing miniaturisation, the number of components and thus the number of soldered joints on an object to be soldered, such as a printed circuit board, continues to increase. In addition, the increasing miniaturisation also leads to the soldered joints being arranged increasingly close together.

In spite of the constant quality improvement of soldering machines, the risk of a soldered object having deficient soldered joints still exists. Although most of soldered objects are subjected to a functional inspection before the soldered object is built into an apparatus, such a functional inspection, which is carried out on a testing machine, for example, which verifies whether all the joints have actually been made, does not provide any indications with regard to soldered joints which, although they do provide galvanic contact, exhibit insufficient mechanical integrity, for example because the solder has not properly bonded to one of the metal parts to be connected. After all, such a soldered joint may initially provide the desired galvanic connection, but said connection can easily be broken as a result of mechanical loads being exerted thereon, differences in temperature and the like. In view of the requirements that are currently made of many electronic circuits, this is unacceptable.

So far, visual inspections have been used. These inspections involve a relatively great deal of human labour, however, whilst the reproducibility of the inspection is generally low in the case of inspection with the human eye.

In order to avoid these problems, the present invention provides an apparatus for visually inspecting soldered joints made on a soldered object, which apparatus is characterized by a camera for recording at least one image of the soldered object on which the soldered joints to be soldered are present, a computing device connected to the camera for receiving the signals from the camera that represent the images recorded by the camera, the computing device being arranged for comparing the signals with signals which are representative of correct soldered joints, and a handling device for moving the soldered objects on which the soldered joints to be inspected have been made to a position within the viewing range of the camera.

To this end, the present invention also provides a method for visually inspecting soldered joints, which method comprises the following steps: moving the soldered objects on which the soldered joint to be inspected is present to a position within the viewing range of the camera; recording an image of the soldered joint to be inspected; comparing a signal representing the image with a reference signal representing an assessment criterion; and delivering a decision signal on the basis of said comparison.

The drawbacks of the method to be carried out in the form of human labour are avoided by using such an apparatus and such a method.

In a number of cases, a single image obtained by the camera does not provide sufficient information for assessing the quality of the soldered joints with a sufficient degree of accuracy.

According to one aspect of the invention, the handling device is therefore arranged for moving the soldered object with respect to the camera. According to one aspect of the method, the position of the object relative to the camera is changed in dependence on the decision signal.

In another preferred embodiment, the handling device is arranged for moving the soldered object in a plane transversely to the optical axis of the camera.

This makes it possible to display the soldered joint to be inspected on a larger scale, for example when the soldered joint to be inspected is displayed on too small a scale in relation to the criteria.

According to another preferred embodiment, the handling device is arranged for moving the soldered object in the plane transversely to the optical axis of the camera.

This makes it possible to visualise particular deficiencies of the soldered joints more clearly.

According to another preferred embodiment, the apparatus is arranged for moving the soldered object to a second position in response to a comparison of the image obtained in the first position of the soldered object with a first criterion stored in the computing device and subsequently comparing the image obtained in said second position with a second criterion.

With these features the invention provides means for removing any doubt as regards the quality of soldered joints in those cases where the image of a soldered joint obtained in a first position contains insufficient information for making a judgment as regards the quality of the soldered joint; in such a doubtful case, the invention arranges for a second image to be made so as to obtain more information.

The present invention will now be explained in more detail with reference to the accompanying drawings, which show in:

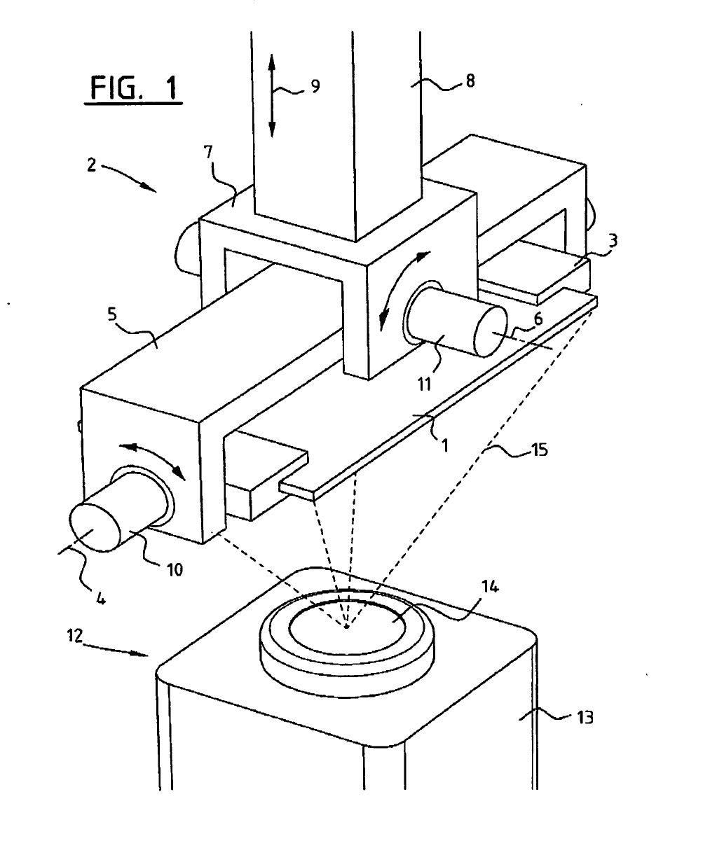

FIG. 1: a perspective schematic view of an apparatus according to the present invention;

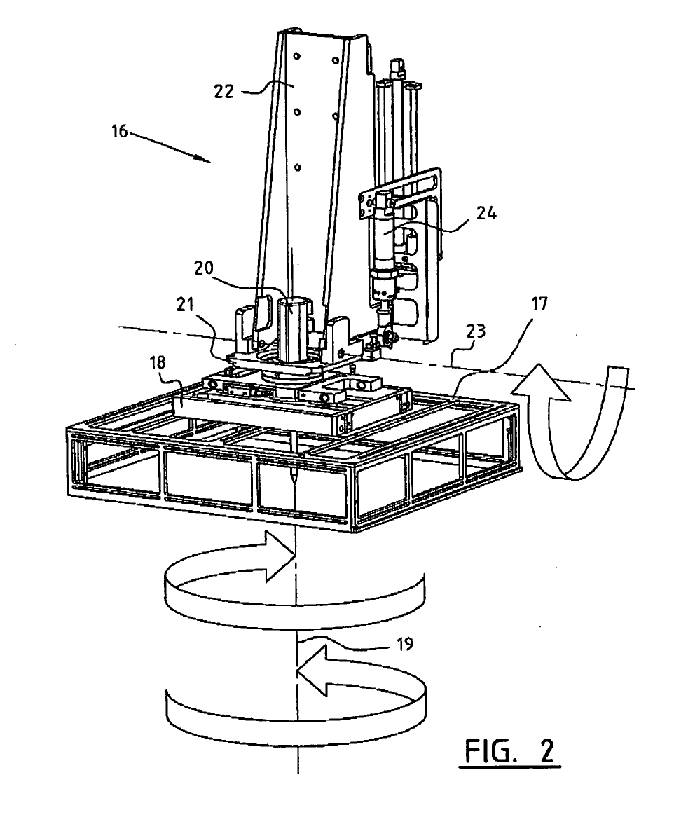

FIG. 2: a perspective view of a first embodiment of an apparatus according to the present invention;

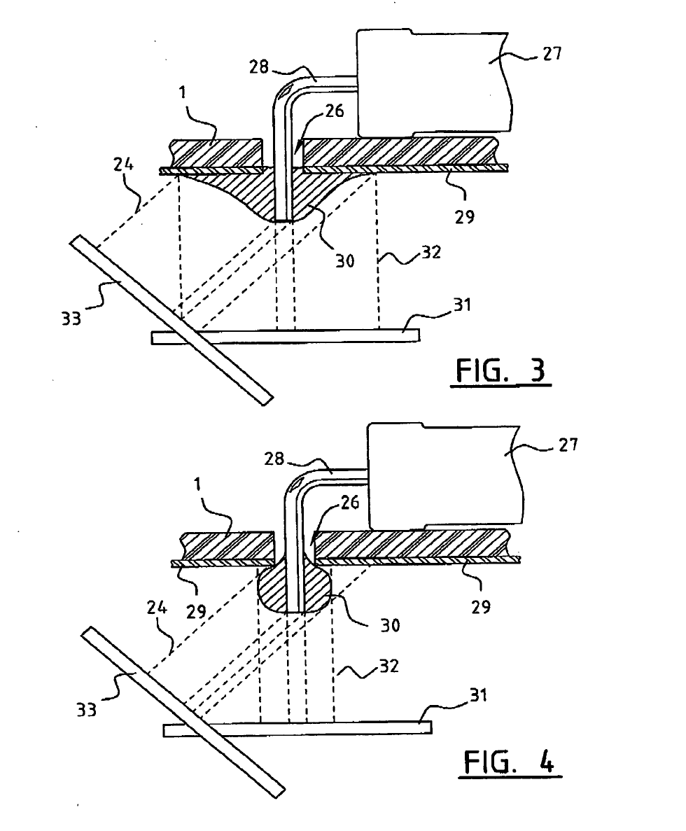

FIG. 3: a schematic sectional view of a correct soldered joint; and

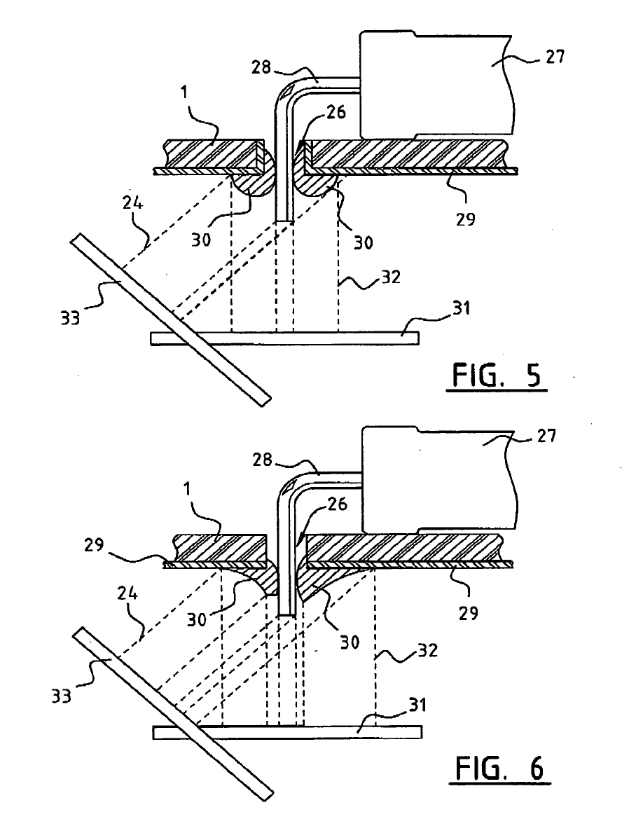

FIGS. 4-6: views corresponding to FIG. 3 of deficient soldered joints.

In FIG. 1 a printed circuit board 1 is shown, on the bottom side of which soldered joints are present. The printed circuit board 1 is held in a handling device, which is indicated as a whole by numeral 2, for inspecting the soldered joints on the printed circuit board 1. The handling device comprises two clamps 3 for clamping down the printed circuit board 1, which clamps are pivotable about an axis 4 in a bracket 5. The bracket 5 is in turn pivotable about an axis 6 in a holder 7, which is mounted to a support 8. The support 8 is movable mainly in vertical direction in the direction indicated by the arrow 9.

A motor 10 mounted to the bracket 5 is used for pivoting the printed circuit board 1. A motor 11 is used for pivoting the bracket 5 about the axis 6. Instead of using the motor is as shown, it is also possible to use other driving elements, such as air cylinders and the like. The handling device 2 may form part of a robot, for example, of which numerous embodiments are possible. Moreover, the handling device may be used for handling the printed circuit board not only for visually displaying the same, but also for carrying out other operations with the printed circuit board, for example picking it up and putting it down, or positioning it above a soldering device, a fluxer, or other treatment device.

In FIG. 1, a camera 12 is shown to be present under the handling device 2, which camera comprises a camera housing 13 and a lens 14. The lens is oriented for placing the printed circuit board 1 within its viewing range, which is defined by the line 15.

Although this embodiment comprises a handling device which is arranged for handling the printed circuit board 1 relative to the camera, it is also possible to maintain the printed circuit board at a fixed position and to have the camera move with respect to the printed circuit board 1. This can for example be done by mounting the camera in a robot or other handling device. It is also possible in this connection to inspect the printed circuit boards “on the fly”, for example, by having the camera move along with a printed circuit board being moved on a conveyor belt, for example.

It is also possible, for example, to use mirrors for exposing soldered joints to the camera.

With the handling device 16 that is shown in FIG. 2, the printed circuit board is clamped down in a gripping element 17. The gripping element is mounted on a support 18, which can be pivoted about a vertical axis 19 by means of a motor 20. The motor 20 is mounted on a tilting plate 21, and it causes the support 18 and thus the gripping device 17 to pivot about the axis 19. The tilting plate 20 is pivotable about a horizontal axis 23 with respect to the supporting structure 22. An air cylinder 24 is used for driving the plate. This construction, too, may form part of a role bought or of another handling device.

FIG. 3 schematically shows a correct soldered joint. In FIG. 3, a printed circuit board 1 is shown, in which a hole 26 is drilled. Present on the printed circuit board 1 is a component, for example a capacitor 27, a connecting wire 28 of which extends through the hole 26. At its bottom side, the printed circuit board is provided with a metal layer 29, generally copper. It will be apparent that this metal layer only extends in accordance with a conductor pattern.

The printed circuit board 1 in question has been subjected to a soldering treatment, as a result of which a correct soldered joint 30 has been formed. Said soldered joint consists of an amount of solder that has bonded both to the metal layer 29 and to the connecting wire 28.

FIG. 3 furthermore shows, at the bottom side thereof, a perpendicular projection surface 31, which is intended for displaying an image on, for example, a CCD recorder of the camera. Lenses and any other optical means are left out of consideration here. The projection of the soldered joint onto the projection surface 31 is illustrated by means of a dotted line 32. Numeral 33 indicates an inclined projection surface for comparison with the situation in which the printed circuit board 1 is tilted with respect to the original horizontal position. Also in this case use is made of projection lines 34 for obtaining an image.

It will be apparent that the projected image is different from the image that is projected onto the projection surface 31.

FIGS. 4, 5 and 6 show different kinds of deficient soldered joints. As the Figures show, a better image of a soldered joint can be obtained in some situations by projecting the soldered joint on a different, inclined surface, so that a better criterion for assessing the quality of the soldered joint is available in the situation as shown.

1. Apparatus for visually inspecting soldered joints made on a soldered object, characterized by:
a camera for recording at least one image of the soldered object on which the soldered joints to be soldered are present;
a computing device connected to the camera for receiving the signals from the camera that represent the images recorded by the camera, the computing device being arranged for comparing the signals with signals which are representative of correct soldered joints; and
a handling device for moving the soldered objects on which the soldered joints to be inspected have been made to a position within the viewing range of the camera.

2. Apparatus according to claim 1, characterized in that said the handling device is arranged for moving the soldered object with respect to the camera.

3. Apparatus according to claim 1 or 2, characterized in that the handling device is arranged for moving the soldered object in a plane transversely to the optical axis of the camera.

4. Apparatus according to any one of the preceding claims, characterized in that the handling device is arranged for moving the soldered object in the plane transversely to the optical axis of the camera.

5. Apparatus according to any one of the preceding claims, characterized in that the handling device is arranged for tilting the soldered object about a first axis extending perpendicularly to the optical axis of the camera.

6. Apparatus according to claim 5, characterized in that the handling device is arranged for tilting the soldered object about a second axis extending perpendicularly to the optical axis of the camera and perpendicularly to said first axis.

7. Apparatus according to any one of the preceding claims, characterized in that the apparatus is arranged for moving the soldered object to a second position in response to a comparison of the image obtained in the first position of the soldered object with a first criterion stored in the computing device and subsequently comparing the image obtained in said second position with a second criterion.

8. Apparatus according to claim 7, characterized in that the apparatus is arranged for reducing the distance between the camera and the soldered object if the first criterion is not met.

9. Apparatus according to claim 7 or 8, characterized in that the apparatus is arranged for tilting the soldered object about an axis extending perpendicularly to said optical axis if the first criterion is not met.

10. Method for visually inspecting soldered joints, which method comprises the following steps:
moving the soldered objects on which the soldered joint to be inspected is present to a position within the viewing range of the camera;
recording an image of the soldered joint to be inspected;
comparing a signal representing the image with a reference signal representing an assessment criterion; and
delivering a decision signal on the basis of said comparison.

11. Method according to claim 10, characterized in that the position of the object relative to the camera is changed in dependence on the decision signal.

12. Method according to claim 11, characterized in that the angle between the optical axis of the camera and the soldered object is changed in dependence on the decision signal.

13. Method according to claim 11 or 12, characterized in that the distance between the camera and the soldered object is changed in dependence on the decision signal.
